(19) United States
(12) Patent Application Publication
(10) Pub. No.: US 2006/0224925 A1
(43) Pub. Date: Oct. 5, 2006

(54) Method and system for analyzing an application

(75) Inventor: John M. Lake, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/099,044

(22) Filed: Apr. 5, 2005

(51) Int. Cl. G06F 11/00

(52) U.S. Cl. 714/38

(57) ABSTRACT

An application is analyzed by obtaining the resource availability for one or more resources of a computer infrastructure. In particular, the resource availability can be obtained while the application is executing and when the application is not executing. By comparing respective resource availabilities, the resource consumption by the application can be determined. Additionally, a power spectrum can be generated based on one or both of the resource availabilities to analyze the behavior and/or resource consumption of various processes. As a result, the invention can be used to analyze the performance of the application, its impact on one or more other applications, compare different versions of the application, or the like, without requiring any knowledge of the application itself.

### BACKGROUND OF THE INVENTION

1. Technical Field

The invention relates generally to analyzing an application, and more particularly, to a solution for analyzing an application that does not require knowledge of the application structure.

2. Background Art

Analysis of the performance characteristics of an application is frequently desired. For example, an application designed to be operated in a long-running fashion is typically expected to provide some set of services while consuming limited and predictable amounts of computing resources. Confirmation that the application operates as expected is desired. However, the accurate analysis of various performance characteristics of an application is considered to be a complex problem, requiring skills acquired over several years of practice. Further, gathering the performance data necessary for the analysis is time consuming, requires a high degree of specialization, and frequently several weeks of effort to perform a baseline analysis of the application. Because of this complexity, such analysis is typically performed infrequently and, when performed, late in the development cycle. Consequently, it is difficult to determine when a performance degrading design or implementation was introduced, and any opportunity to address a performance challenge during the development cycle is reduced.

Most applications of interest are large and complex, and include some persistent processes and threads and some transient processes and threads. For these applications, the analysis literature provides a tracking approach that starts with a root process, accounts for each process descending from the root process, and computes the performance characteristics of each process. This approach poses several difficulties and requires a high degree of familiarity with the application under evaluation. For example, the number of root processes that may be included in the application and their corresponding interrelationships will need to be known. This becomes problematic when the structure of the application changes between evaluations, for example, during development of the application.

The problem is considerably more difficult when the analysis seeks to determine the potentially deleterious effects of application collocation. This can occur when building a complex software image (such as is typical in modern datacenters) that includes not just the operating system and the application of interest, but also includes monitoring software such as Tivoli Monitoring offered by International Business Machines Corp. of Armonk, N.Y., or when consolidating multiple applications onto a single server. In such cases, performance data collected for each individual application may not be indicative of the performance or resource requirements of the collocated applications, since the combined applications compete for resources in ways not measured in typical performance runs. For example, two applications that run well within the resource capacity of two separate servers may, when combined onto a single server, compete for memory- and/or I/O-bus bandwidth in ways that are ultimately unacceptable. Similarly, the additional work performed on the single server may have complex interactions with the application of interest. For example, in certain cases, monitoring software injects additional work into the application of interest as it retrieves metric data from a specialized interface, then competes for CPU, I/O bandwidth, memory, and other resources that may be critical to the operation of the monitored application.

To this extent, a need exists for an improved solution for analyzing an application. In particular, a need exists for a method and system that analyze the application and/or multiple applications based on the availability of a set of resources for a computer infrastructure. In this manner, no knowledge of any particular application is required to perform the analysis.

### SUMMARY OF THE INVENTION

The invention provides a solution for analyzing a target application and/or an agglomeration of applications. In particular, resource availability for one or more resources for a computer infrastructure is obtained both with the target application executing on the computer infrastructure and without the target application executing. In one embodiment, a workload application processes a sample workload, and the amount of time required to process the sample workload is obtained. Further, an availability of one or more resources is periodically sampled while the sample workload is processed. Based on this data, an amount of the resource that was consumed by the target application can be determined. Further, a power spectrum can be generated based on the resource availability for each configuration (e.g., with and without the target application executing). The power spectrum can reveal the periodicity and timing of one or more processes. To this extent, the invention can further analyze an agglomeration of applications executing on a computer infrastructure and/or an impact on performance characteristics of the agglomeration after the addition of the target application. As a result, the invention provides a solution that can analyze a target application, different versions of the target application, and/or an impact that the target application has on one or more other applications executing on the same computer infrastructure without requiring any special knowledge of the application(s).

A first aspect of the invention provides a method of analyzing a target application, the method comprising: obtaining a reference availability of a resource for a computer infrastructure and a reference time period by processing a sample workload using the computer infrastructure without the target application executing; obtaining a target availability of the resource and a target time period by processing the sample workload using the computer infrastructure with the target application executing; and analyzing the target application based on the reference availability, the reference time period, the target availability and the target time period.

A second aspect of the invention provides a system for analyzing a target application, the system comprising: a system for obtaining a reference availability of a resource for a computer infrastructure and a reference time period by processing a sample workload using the computer infrastructure without the target application executing; a system for obtaining a target availability of the resource and a target time period by processing the sample workload using the computer infrastructure with the target application executing; and a system for analyzing the target application based on the reference availability, the reference time period, the target availability and the target time period.

A third aspect of the invention provides a method of analyzing a set of applications, the method comprising: obtaining a reference availability of a resource for a computer infrastructure and a reference time period by processing a sample workload using the computer infrastructure without a target application executing; obtaining a target availability of the resource and a target time period by processing the sample workload using the computer infrastructure with the target application executing; generating a power spectrum based on the reference availability; generating a power spectrum based on the target availability; and analyzing the set of applications using the power spectrums.

A fourth aspect of the invention provides a program product stored on a computer-readable medium, which when executed, analyzes a target application, the program product comprising: program code for obtaining a reference availability of a resource for the computer infrastructure and a reference time period by processing a sample workload using the computer infrastructure without the target application executing; program code for obtaining a target availability of the resource and a target time period by processing the sample workload using the computer infrastructure with the target application executing; and program code for analyzing the target application based on the reference availability, the reference time period, the target availability and the target time period.

A fifth aspect of the invention provides a computer-readable medium that includes computer program code to enable a computer infrastructure to analyze an application.

A sixth aspect of the invention provides a business method for analyzing an application.

A seventh aspect of the invention provides a method of generating a system for analyzing an application.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for analyzing an application;

FIG. 2 shows an illustrative method of obtaining availability data;

FIG. 3 shows illustrative availability data for a single resource;

FIG. 4 shows an illustrative graph that comprises two power spectrums, each corresponding to a different version of an application; and

FIG. 5 shows an illustrative graph that comprises two power spectrums, each corresponding to a different configuration of a computer infrastructure.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for analyzing a target application and/or an agglomeration of applications. In particular, resource availability for one or more resources for a computer infrastructure is obtained both with the target application executing on the computer infrastructure and without the target application executing. In one embodiment, a workload application processes a sample workload, and the amount of time required to process the sample workload is obtained. Further, an availability of one or more resources is periodically sampled while the sample workload is processed. Based on this data, an amount of the resource that was consumed by the target application can be determined. Further, a power spectrum can be generated based on the resource availability for each configuration (e.g., with and without the target application executing). The power spectrum can reveal the periodicity and timing of one or more processes. To this extent, the invention can further analyze an agglomeration of applications executing on a computer infrastructure and/or an impact on performance characteristics of the agglomeration after the addition of the target application. As a result, the invention provides a solution that can analyze a target application, different versions of the target application, and/or an impact that the target application has on one or more other applications executing on the same computer infrastructure without requiring any special knowledge of the application(s).

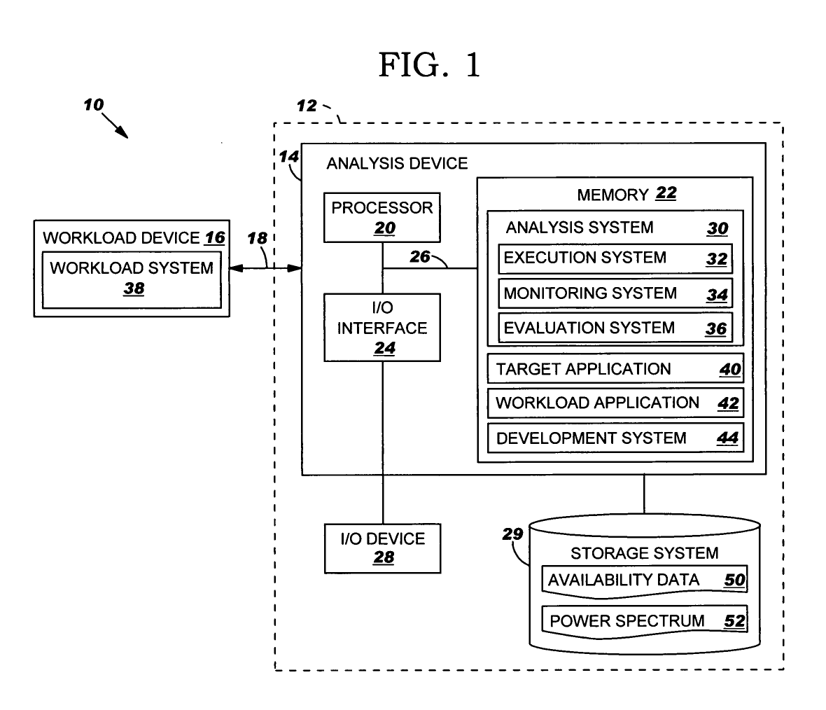

Turning to the drawings, FIG. 1 shows an illustrative system 10 for analyzing an application, such as target application 40. To this extent, system 10 includes a computer infrastructure 12 that can perform the various process steps described herein for analyzing target application 40. In particular, computer infrastructure 12 is shown including an analysis device 14 that comprises an analysis system 30, which enables analysis device 14 to analyze target application 40 by performing the process steps of the invention.

Analysis device 14 is shown including a processor 20, a memory 22, an input/output (I/O) interface 24, and a bus 26. Further, analysis device 14 is shown in communication with an external I/O device/resource 28 and a storage system 29. As is known in the art, in general, processor 20 executes computer program code, such as analysis system 30, that is stored in memory 22 and/or storage system 29. While executing computer program code, processor 20 can read and/or write data, such as availability data 50, to/from memory 22, storage system 29, and/or I/O interface 24. Bus 26 provides a communications link between each of the components in analysis device 14. I/O device 28 can comprise any device that enables a user (not shown) to interact with analysis device 14 or any device that enables analysis device 14 to communicate with one or more other computing devices, such as workload device 16.

In any event, analysis device 14 can comprise any general purpose computing article of manufacture capable of executing computer program code installed by a user (e.g., a personal computer, server, handheld device, etc.). However, it is understood that analysis device 14 and analysis system 30 are only representative of various possible computing devices that may perform the various process steps of the invention. To this extent, in other embodiments, analysis device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

To this extent, computer infrastructure 12 can further comprise a workload device 16. Workload device 16 is shown in communication with analysis device 14 over a communications link 18. As discussed above, communications link 18 can comprise any combination of various types of communications links as is known in the art. In one embodiment, workload device 16 comprises a computing device that is in communication with analysis device 14 over a local area network such as an internal network of a company. Regardless, it is understood that workload device 16 can comprise the same components (processor, memory, I/O interface, etc.) as shown for analysis device 14. These components have not been separately shown and discussed for brevity.

As previously mentioned and discussed further below, analysis system 30 enables computing device 14 to analyze target application 40. To this extent, analysis system 30 is shown including an execution system 32 for executing target application 40, a monitoring system 34 that obtains availability data 50 for one or more resources of computing infrastructure 12, and an evaluation system 36 for analyzing target application 40 based on the availability data 50. Operation of each of these systems is discussed further below. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of system 10. To this extent, workload device 16 is shown including a workload system 38 that can provide a workload for processing by analysis device 14, and which could be implemented on analysis device 14 or not included in system 10.

Regardless, the invention provides a method and system for analyzing an application, such as target application 40. To this extent, the invention obtains availability data 50 for a set (one or more) of resources of a computer infrastructure 12 that executes target application 40. As is known, the set of resources can comprise any combination of numerous types of resources of computer infrastructure 12 and/or analysis device 14. For example, a resource can comprise processor 20. In this case, an availability of processor 20 can be obtained based on an amount of processing time that was not used. In the Windows™ operating system, the availability can be based on the processing time allocated to the system “idle process”. Additionally, a resource can comprise one or more types of memory 22. In this case, an availability of memory 22 can be obtained based on an amount memory consumed by executing processes. For example, the availability can be based on an amount of configured virtual memory and a “commit charge”, i.e., an operating system metric characterizing the amount of memory committed to executing processes. Processor 20 and memory 22 are only illustrative resources. To this extent, the availability of various other resources could be obtained. For example, an availability of the bandwidth for one or more communications devices, an availability of a storage device, etc., could be obtained, as well as others that will be recognized by one in the art.

In one embodiment, target application 40 can be analyzed based on its impact on processing a sample workload (e.g., data) using computer infrastructure 12. For example, analysis device 14 can comprise a workload application 42 that processes the sample workload. Further, workload device 16 can comprise a workload system 38 that provides the sample workload for processing by workload application 42. In this case, workload application 42 can receive the sample workload from workload system 38 and process the sample workload both with target application 40 executing and without target application 40 executing. During each execution, availability data 50 for each of the set of resources can be obtained along with a time period that was required to process the sample workload using computer infrastructure 12 and workload application 42.

Further, target application 40 can be analyzed based on its impact on workload application 42. In this case, availability data 50 can be further obtained for computer infrastructure 12 when neither target application 40 nor workload application 42 is executing. With this additional data, the performance of workload application 42 can be analyzed both with target application 40 concurrently executing and without target application 40 concurrently executing.

In any event, by processing the sample workload, workload application 42 ensures that computer infrastructure 12 is concurrently executing at least one additional application. As a result, availability data 50 should more accurately reflect an actual performance of target application 40 once deployed. Further, by using the same sample workload, variables such as the data currently being processed, other applications concurrently executing, and the like, can be reduced between executions. It is understood that various additional measures can be taken to reduce the variables between executions. For example, analysis device 14 can be removed from a public network, one or more applications and/or processes (e.g., a screen saver) can be stopped/halted during each execution, and the like.

One or more additional precautions/actions can be taken/implemented in order to reduce the impact of any variations between executions. For example, multiple executions of the same configuration (e.g., only workload application 42 executing, both target application 40 and workload application 42 executing, neither target application 40 nor workload application 42 executing) can be performed and availability data 50 for each execution can be obtained. Subsequently, availability data 50 for each configuration can be calculated based on the availability data 50 for the multiple executions (e.g., an average of all). Additionally, a size of the sample workload and/or a minimum time period for each execution can be selected to ensure that any periodic processes that may consume processing time will have a relatively small impact from execution to execution (e.g., likely to occur approximately the same number of times for each execution).

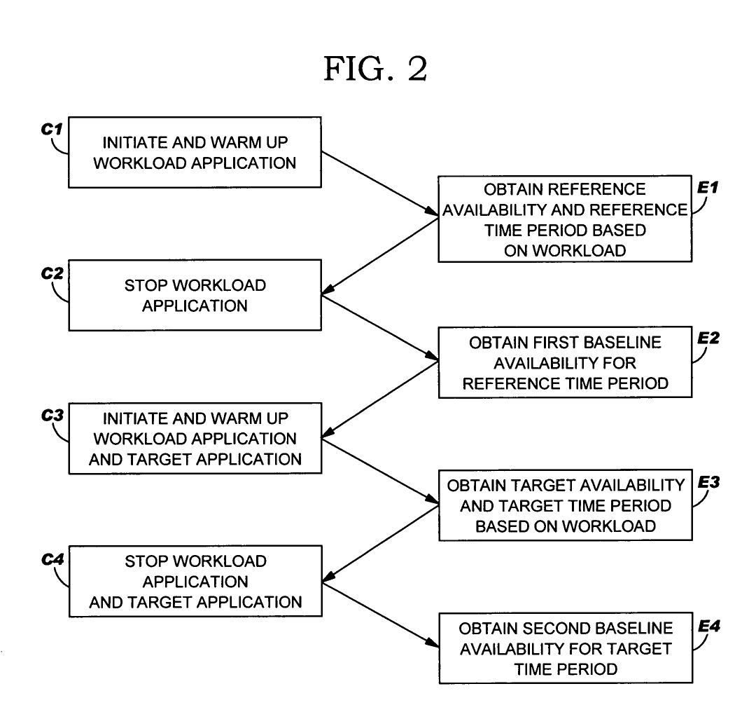

The various process steps of the invention will be further discussed with reference to FIG. 2, which shows an illustrative method of obtaining availability data 50, in conjunction with FIG. 1. To this extent, FIG. 2 comprises various configuration steps C1-C4, each of which is followed by a corresponding execution step E1-E4 that obtains availability data 50 for the particular configuration. These steps obtain a baseline availability, a reference availability, and a target availability for one or more resources that can subsequently be used to analyze target application 40 and/or workload application 42 as discussed above.

In step C1, execution system 32 can initiate and/or warm up workload application 42. For example, execution system 32 can request that an operating system or the like initiate workload application 42 using a system function call or the like. Further, one or more startup options, if desired, can be specified by execution system 32. In one embodiment, execution system 32 can generate a user interface or the like that enables a user to selectively initiate workload application 42, identify workload application 42, etc. Regardless, once initiated, execution system 32 can warm up workload application 42 by, for example, allowing process(es) and/or data for workload application 42 to completely load into memory, causing workload application 42 to process preliminary data, configuring workload application 42 so that it is prepared to process the sample workload, or the like.

Once workload application 42 is ready, flow can proceed to step E1, in which monitoring system 34 obtains availability data 50 that includes a reference availability of each resource in a set of resources for computer infrastructure 12 and a reference time period. In particular, execution system 32 can signal workload system 38 to start providing a sample workload for processing by workload application 42. Further, monitoring system 34 can obtain the reference availability for each resource in the set of resources while workload application 42 is processing the sample workload. For example, monitoring system 34 can obtain the reference availability by sampling once a second for the duration of the step, although any appropriate sampling period can be used. Once all of the sample workload has been processed by workload application 42, workload system 38 can indicate that the processing is complete, and monitoring system 34 can stop the sampling and determine the reference time period. For example, the reference time period can comprise the time period between when workload system 38 started providing the sample workload and when workload system 38 indicated that the sample workload had been completely processed.

In step C2, execution system 32 can stop workload application 42. Consequently, neither workload application 42 nor target application 40 would be executing on computer infrastructure 12. To this extent, computer infrastructure 12 would not be processing the sample workload. Subsequently, in step E2, monitoring system 34 can obtain availability data 50 that comprises a baseline availability of each resource in the set of resources for the reference time period obtained from step E1. In particular, monitoring system 34 can periodically sample the availability of each resource as discussed above until the reference time period expires.

Once completed, in step C3, execution system 32 can initiate and/or warm up target application 40 and workload application 42. As discussed above, each application 40, 42 can be initiated through a system call or the like, and can be warmed up by allowing the various processes and corresponding data to initialize and load into memory. Once applications 40, 42 are ready, monitoring system 34 can obtain availability data 50 that comprises a target availability of each resource in the set of resources and a target time period. In particular, as discussed above, workload system 38 can provide the sample workload for processing by workload application 42 and monitoring system 34 can periodically sample the availability of each resource in the set of resources while workload application 42 is processing the sample workload. Once the processing is complete, monitoring system 34 can determine the target time period in the same manner as the reference time period was determined above.

In step C4, execution system 32 can stop workload application 42 and target application 40 so that neither workload application 42 nor target application 40 is executing in computer infrastructure 12, and in step E4, monitoring system 34 can obtain availability data 50 that comprises a second baseline availability for the target time period determined in step E3. In particular, monitoring system 34 can periodically sample the availability of each resource as discussed above until the target time period expires.

It is understood that one or more of the execution steps E1-E4 described above could comprise obtaining preliminary availability data 50 multiple times. Further, one or more configuration step C1-C4 and execution step E1-E4 pairs could be repeated multiple times. In either case, in steps E1 and E3, execution system 32 could signal workload system 38 to start providing the same sample workload for processing by workload application 42. Subsequently, workload application 42 can process the workload data and monitoring system 34 can obtain preliminary availability data 50. In general, each time the sample workload is processed, availability data 50 will vary, e.g., the resource availability may be higher/lower and/or the time period may be longer/shorter. After all of the preliminary availability data 50 has been obtained, monitoring system 34 can calculate the corresponding availability and the corresponding time period based on the preliminary availability data 50. For example, monitoring system 34 could average all of the preliminary availability data 50. Further, monitoring system 34 could ignore an execution that exceeded a certain threshold (e.g., a preliminary time period was much longer than all other executions) as likely being inaccurate due to an anomaly.

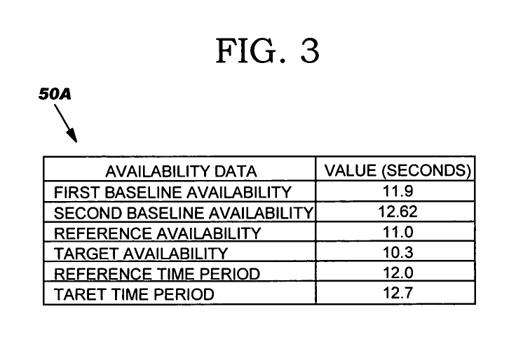

In any event, evaluation system 36 can analyze target application 40 and/or workload application 42 based on availability data 50. For example, FIG. 3 shows illustrative availability data 50A that could be obtained using the steps of FIG. 2 for a single resource. Referring to FIGS. 1 and 3, based on availability data 50A, evaluation system 36 can calculate an amount of the resource consumed by workload application 42 by, for example, subtracting the reference availability from the first baseline availability (e.g., 11.9−11.0=0.9). As a percentage of the total resource consumption, this value can be divided by the first baseline availability (e.g., 0.9/11.9=7.6%). Similarly, evaluation system 36 can calculate an amount of the resource consumed by target application 40 and workload application 42 by, for example, subtracting the target availability from the second baseline availability (e.g., 12.62−10.3=2.32), or as a percentage of the total resource consumption, dividing the value by the second baseline availability (e.g., 2.32/12.62=18.4%). Based on these values, evaluation system 36 can calculate an amount of the resource consumed by target application 40 by, for example, subtracting the amount consumed by workload application 42 alone from the amount consumed by target application 40 and workload application 42 (e.g., 2.32−0.9=1.42), or as a percentage of the total resource consumption, dividing the value by the second baseline availability (e.g., 1.42/12.62=11.25%). Note, however, that the percentage consumed by workload application 42 alone (7.6%) and the percentage consumed by target application 40 alone (11.25%) do not add up to the percentage consumed by both (18.4%). This is due to the fact that two different time periods are used in the calculations.

It is understood that the method steps of FIG. 2 and the corresponding availability data 50A shown in FIG. 3 are only illustrative. For example, referring to FIGS. 1 and 2, in order to analyze only target application 40, monitoring system 34 would not need to obtain the first and second baseline availabilities in steps E1 and E4. Rather, the reference availability and reference time period can be compared to the target availability and target time period to analyze the amount of resources consumed by target application 40 and its relative impact on workload application 42. Similarly, rather than obtaining the second baseline availability by periodically sampling the availability for the target time period in step E4, monitoring system 34 could derive the value from other availability data 50. For example, monitoring system 34 could estimate the second baseline availability by extending the percentage for the first baseline availability for the target time period.

As a result, no understanding of the internal characteristics of target application 40 and/or workload application 42 was necessary to successfully analyze either or both. This analysis can be used to determine various performance metrics of interest. For example, in order to determine if workload application 42 can achieve its target response-time performance goals while target application 40 is concurrently executing on computer infrastructure 12, sampling performed while the sample workload is received and processed by workload application 42 is all that is required. To this extent, the above-described availability data 50 can be analyzed to make such a determination.

In another embodiment, the process of the invention can be used to analyze different versions of target application 40. For example, a user can modify one or more development objects used to generate target application 40 using development system 44. Once the modifications are complete, development system 44 can create a new version of target application 40. The user can then provide target application 40 to analysis system 30 for analysis. After receiving the new version of target application 40, analysis system 30 can obtain availability data 50 (e.g., a second target availability and a second target time period) for the new version of target application 40, analyze availability data 50 as described above, and compare the new version of target application 40 with the previous version of target application 40. In this manner, a developer can quickly determine whether a modification has adversely impacted the performance of target application 40.

Evaluation system 36 can analyze other aspects of target application 40 and/or workload application 42 based on availability data 50. To this extent, one or more changes in the internal structure of target application 40 could be detected between versions of target application 40. For example, for a target application 40 (e.g., one built on a periodic task model or a stimulus-response model), a power spectrum generated based on availability data 50 (e.g., in the Fourier analysis sense) can reveal the internal structure of target application 40 by showing how it is consuming the set of resources as it executes. To this extent, a change in the power spectrum between versions can be used to determine a performance improvement and/or degradation in the execution of target application 40 (e.g., one or more periodic tasks). Again, evaluation system 36 can perform this analysis without detailed knowledge of the structure of target application 40. However, an examination of the power spectrum can reveal relatively fine-grained information about target application 40, such as the periodicities of the task(s) and the amount of the set of resources consumed on each periodicity. For many applications, one or more desired periodicities are part of the configuration. In this case, examination of the power spectrum at different times and/or across different time scales can also indicate a degree of deviation from the desired periodicities.

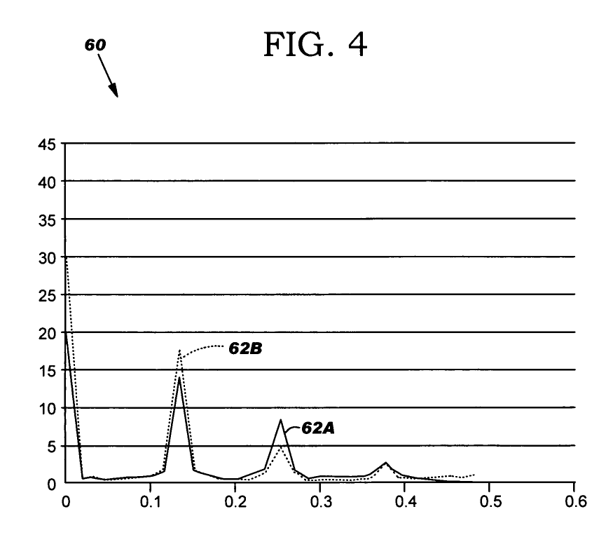

For example, FIG. 4 shows an illustrative graph 60 that comprises two power spectrums 62A-B, each corresponding to a different version of target application 40 (FIG. 1). Referring to FIGS. 1 and 4, evaluation system 36 can generate each power spectrum 62A-B based on the target availability for a different version of target application 40. To this extent, monitoring system 34 can obtain availability data 50 that comprises target availability for a first version of target application 40 and target availability for a second version of target application 40. As described above, the target availability can comprise a periodic sampling of the availability of one or more resources (e.g., idle process time). Based on the target availability, evaluation system 36 can readily determine the periodic consumption (e.g., 1—availability) for each resource in the set of resources. Subsequently, evaluation system 36 can generate each power spectrum 62A-B by computing a discrete Fourier Transform (DFT) of the periodic consumption for each resource.

As can be seen in FIG. 4, power spectrums 62A-B illustrate concentrations of “power” at certain base frequencies and harmonics. These concentrations reflect the presence of a periodic task and the relative peaks capture the relative differences in consumption of the resource for the corresponding target availability. To this extent, power spectrum 62A reflects a lower cumulative resource consumption (and therefore requirement) for the corresponding version of target application 40 (FIG. 1) than the version of target application 40 that corresponds to power spectrum 62B.

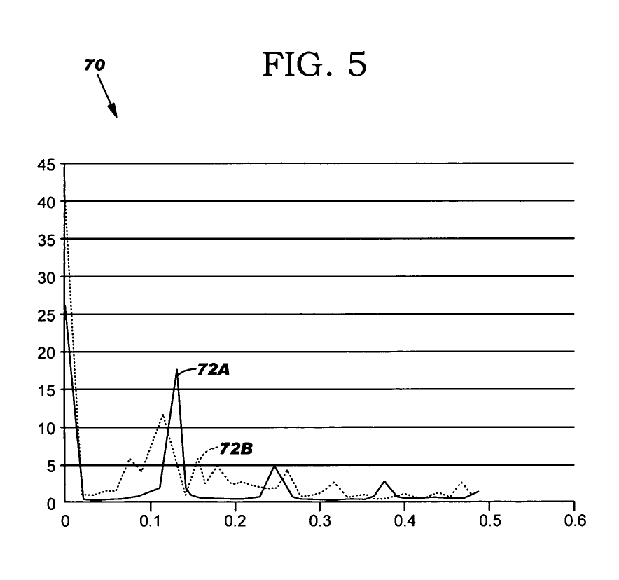

Similarly, power spectrums can be used to compare the resource consumption between different configurations of computer infrastructure 12 (FIG. 1). To this extent, FIG. 5 shows an illustrative graph 70 that comprises two power spectrums 72A-B, each corresponding to a different configuration of computer infrastructure 12. For example, referring to FIGS. 1 and 5, power spectrum 72A could correspond to the resource consumption when workload application 42 was executed without target application 40 and power spectrum 72B could correspond to the resource consumption when both workload application 42 and target application 40 were executing. As can be seen, power spectrum 72B reflects the presence of two processes that interfere with one another, and have less predictable resource consumption than that shown in power spectrum 72A. It is understood that graphs 60 (FIG. 4) and 70 are only illustrative. To this extent, a longer period and/or higher sampling rate could be used to obtain better resolution and allow for better analysis. Further, it is understood that additional power spectrums 72A-B could be included on either graph 60, 70. For example, evaluation system 36 could generate a power spectrum based on one or both baseline activities for display in graph 70.

Similarly, evaluation system 34 can perform spectral analysis on the resource consumption for one or more key processes whose identities are well known and/or easy to identify (e.g., persistent processes). The resource consumption for these processes can be used to decompose the availability data 50 into known consumers and unknown consumers, giving a characterization of the “unexplained” resource consumption which may guide more costly data gathering and analysis techniques. Additionally, evaluation system 34 can normalize the resource consumption against a moving average (linear fit), essentially conjuring up a “known” consumer to account for the characteristics of the underlying operating system and/or data collection routine. This technique is useful for removing various aperiodic data (and is well-known to FFT practitioners).

While shown and described herein as a method and system for analyzing an application, it is understood that the invention further provides various alternative embodiments. For example, in one embodiment, the invention provides a computer-readable medium that includes computer program code to enable a computer infrastructure to analyze an application. To this extent, the computer-readable medium includes program code, such as analysis system 30 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 29 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to analyze an application and/or a set of applications as described above. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for analyzing a target application. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as analysis device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of analyzing a target application, the method comprising:
obtaining a reference availability of a resource for a computer infrastructure and a reference time period by processing a sample workload using the computer infrastructure without the target application executing;
obtaining a target availability of the resource and a target time period by processing the sample workload using the computer infrastructure with the target application executing; and
analyzing the target application based on the reference availability, the reference time period, the target availability and the target time period.

2. The method of claim 1, further comprising obtaining a baseline availability of the resource for the reference time period without processing the sample workload and without the target application executing, wherein the analyzing step is further based on the baseline availability.

3. The method of claim 1, further comprising warming up the target application before the obtaining a target availability step.

4. The method of claim 1, wherein the resource comprises one of a processor or a memory.

5. The method of claim 1, wherein the analyzing step includes calculating an amount of the resource consumed by the target application.

6. The method of claim 1, wherein at least one of the obtaining steps includes:
performing the processing a plurality of times to obtain preliminary availability data for the corresponding availability and the corresponding time period; and
calculating the corresponding availability and the corresponding time period based on the preliminary availability data.

7. The method of claim 1, wherein the analyzing step includes generating a power spectrum based on the target availability.

8. The method of claim 7, wherein the analyzing step further includes generating a power spectrum based on the reference availability.

9. The method of claim 8, further comprising analyzing an impact of the target application on a set of applications based on the power spectrums.

10. The method of claim 1, further comprising:
receiving a new version of the target application;
repeating the obtaining a target availability and analyzing steps for the new version of the target application; and
comparing the new version of the target application with the original target application.

11. A method of generating a system for analyzing a target application, the method comprising:
obtaining a computer infrastructure; and
for each of the steps of claim 1, deploying a means for performing the step to the computer infrastructure.

12. A computer-readable medium for enabling a computer infrastructure to analyze a target application, the computer-readable medium comprising computer program code for performing the method steps of claim 1.

13. A system for analyzing a target application, the system comprising:
a system for obtaining a reference availability of a resource for a computer infrastructure and a reference time period by processing a sample workload using the computer infrastructure without the target application executing;
a system for obtaining a target availability of the resource and a target time period by processing the sample workload using the computer infrastructure with the target application executing; and
a system for analyzing the target application based on the reference availability, the reference time period, the target availability and the target time period.

14. The system of claim 13, further comprising a system for obtaining a baseline availability of the resource for the reference time period without processing the sample workload and without the target application executing, wherein the target application analysis is further based on the baseline availability.

15. The system of claim 13, wherein the resource comprises one of a processor or a memory.

16. The system of claim 13, wherein the system for analyzing calculates an amount of the resource consumed by the target application.

17. The system of claim 13, wherein the system for analyzing generates a power spectrum for at least one of the target availability or the reference availability.

18. The system of claim 13, further comprising:
a system for receiving a new version of the target application, wherein the system for obtaining a target availability obtains a second target availability and a second target time period for the new version of the target application; and
a system for comparing the new version of the target application with the original target application.

19. A method of analyzing a set of applications, the method comprising:
obtaining a reference availability of a resource for a computer infrastructure and a reference time period by processing a sample workload using the computer infrastructure without a target application executing;
obtaining a target availability of the resource and a target time period by processing the sample workload using the computer infrastructure with the target application executing;
generating a power spectrum based on the reference availability;
generating a power spectrum based on the target availability; and
analyzing the set of applications using the power spectrums.

20. The method of claim 19, further comprising obtaining a baseline availability of the resource for the reference time period without processing the sample workload and without the target application executing, wherein the power spectrums are further based on the baseline availability.

21. The method of claim 19, further comprising:
receiving a new version of the target application;
obtaining a new target availability of the set of resources and a new target time period by processing the sample workload using the computer infrastructure with the new version of the target application executing;
generating a new power spectrum based on the new target availability; and
comparing the new version of the target application with the original target application.

22. The method of claim 19, wherein at least one of the obtaining steps includes:
performing the processing a plurality of times to obtain preliminary availability data for the corresponding availability and the corresponding time period; and
calculating the corresponding availability and the corresponding time period based on the preliminary availability data.

23. The method of claim 19, further comprising analyzing the target application based on the reference availability, the reference time period, the target availability and the target time period.

24. A program product stored on a computer-readable medium, which when executed, analyzes a target application, the program product comprising:
program code for obtaining a reference availability of a resource for the computer infrastructure and a reference time period by processing a sample workload using the computer infrastructure without the target application executing;
program code for obtaining a target availability of the resource and a target time period by processing the sample workload using the computer infrastructure with the target application executing; and
program code for analyzing the target application based on the reference availability, the reference time period, the target availability and the target time period.
